(19) United States
(12) Patent Application Publication
(10) Pub. No.: US 2025/0222869 A1
(43) Pub. Date: Jul. 10, 2025

(54) METHODS AND SYSTEMS FOR GENERATING AND DISPLAYING A VIRTUAL BOTTOM VIEW ASSOCIATED WITH A VEHICLE

(71) Applicant: Valeo Schalter und Sensoren GmbH, Bietigheim-Bissingen (DE)

(72) Inventors: Xinhua XIAO, Bietigheim-Bissingen (DE); Peter GROTH, Bietigheim-Bissingen (DE)

(21) Appl. No.: 18/405,154

(22) Filed: Jan. 5, 2024

(51) Int. Cl. B60R 1/23; B60L 53/124; G06T 7/579; G06T 15/20

(52) U.S. Cl. CPC B60R 1/23; B60L 53/124; G06T 7/579; G06T 15/20; B60R 2300/806; G06T 2207/30252; G06T 2210/62

(57) ABSTRACT

Methods and systems for generating and displaying a virtual bottom view associated with a vehicle. Cameras generate images of a parking zone. A processor is programmed to generate image data associated with a first region of the parking zone that includes an object. Movement sensors generate movement data associated with movement of the vehicle during the time in which the image data is generated. A Structure from Motion (SfM) model generates a three-dimensional view associated with the object. Subsequently, when the object is out of view of the cameras, a synthesis model is executed to synthesize the current live view with the three-dimensional view. A virtual bottom view is displayed on a vehicle display during a parking event based on the synthesis, enabling a user to see a three-dimensional virtual view of the object when the object is not in the current field of view during the parking event.

### TECHNICAL FIELD

The present disclosure relates to methods and systems for generating and displaying a virtual bottom view. In embodiments, Structure from Motion (SfM) is utilized to generate a three-dimensional construction of an object that may be hard to visualize from direct camera views, given the location of the object relative to the cameras.

### BACKGROUND

Existing surround-view, 360-degree view, and bird-eye-view camera systems gather images captured by cameras positioned at various locations around the vehicle and generate a live view of the vehicle's surroundings that is displayed on a vehicle display for the vehicle operator to see. These systems may apply image processing techniques to the images captured by each camera at a given point in time to generate the live view. For example, the image processing techniques may include identifying common features between the camera images, aligning the images according to the common features, and combining or stitching the images together to create a single view of the vehicle's surroundings for display.

The generated image on the display may also include a fake image (e.g., a template or mask) of the vehicle. This image of the vehicle is not a live image, but rather a stock or pre-selected image of a vehicle with the same or similar make, model, and/or color of the vehicle. However, vehicles do not typically include a camera that captures live images of road surfaces below the vehicle. Therefore, a live view of the road surface beneath the vehicle is typically not available. The driver is therefore left unable to see potential hazards and objects beneath the vehicle.

### SUMMARY

According to an embodiment, a system for generating and displaying a virtual bottom view associated with a vehicle includes a plurality of cameras, one or more movement sensors, and a processor. The processor is programmed to: generate, via the one or more cameras and during a first time period, first image data associated with a first region of a parking zone external to the vehicle, wherein the first region of the parking zone includes an object; generate, via the one or more movement sensors, movement data associated with movement of the vehicle while the first image data is generated; execute a Structure from Motion (SfM) model based on the first image data generated during the first time period and the associated movement data, wherein the execution of the SfM model generates a three-dimensional view associated with the object; generate, via the one or more cameras and during a second time period subsequent the first time period, a real-time view of a second region of the parking zone within a current field of view of the one or more cameras, wherein the object is not in the current field of view during the second time period; execute a synthesis model to synthesize the real-time view with the three-dimensional view during the second time period in which the object is not in the current field of view; and generate and display a virtual bottom view on a vehicle display during a parking event, wherein the virtual bottom view is generated based on the synthesized real-time view and the three-dimensional view, enabling a user to see a three-dimensional virtual view of the object when the object is not in the current field of view during the parking event.

According to an embodiment, a system for generating and displaying a virtual bottom view associated with a vehicle includes one or more cameras configured to generate image data associated with a parking zone, one or more vehicle sensors configured to generate movement data associated with movement of the vehicle, and one or more processors. The one or more processors are programmed to: receive the image data from the one or more cameras generated during movement of the vehicle; execute a semantic segmentation model on the received image data to categorize a portion of the received image data as being associated with an object in the parking zone; execute a Structure from Motion (SfM) model on the categorized portion of the image data and the movement data, wherein the execution of the SfM model generates a three-dimensional view of the object; generate a virtual bottom view based on the image data, wherein the virtual bottom view includes a virtual view of an area of the parking zone that is not within a current field of view of the one or more cameras, and wherein the virtual view includes the three-dimensional view of the object; and display the virtual bottom view on a vehicle display during a parking event, enabling a user to see the three-dimensional view of the object when the object is not within the current field of view of the one or more cameras.

According to an embodiment, a method of generating and displaying a virtual bottom view associated with a vehicle includes the following: generating, via one or more cameras and during a first time period, first image data associated with a first region of a parking zone external to a vehicle, wherein the first region of the parking zone includes an object; generating, via one or more movement sensors, movement data associated with movement of the vehicle while the first image data is generated; executing a Structure from Motion (SfM) model based on the first image data generated during the first time period and the associated movement data, wherein the executing of the SfM model generates a three-dimensional view associated with the object; generating, via the one or more cameras during a second time period subsequent the first time period, a real-time view of a second region of the parking zone within a current field of view of the one or more cameras, wherein the object is not in the current field of view during the second time period; executing a synthesis model to synthesize the real-time view with the three-dimensional view during the second time period in which the object is not in the current field of view; generating, for display on a vehicle display, a virtual bottom view during a parking event, wherein the virtual bottom view is generated based on the synthesized real-time view and the three-dimensional view, enabling a user to see a three-dimensional virtual view of the object when the object is not in the current field of view during the parking event.

### BRIEF DESCRIPTION OF THE DRAWINGS

FIG. 1 illustrates a block diagram depicting an example system of generating and displaying a virtual bottom view associated with a vehicle, according to an embodiment.

FIG. 2 illustrates an example operational diagram for implementing the system of FIG. 1, according to an embodiment.

FIG. 3 illustrates an overhead schematic view of a parking zone and various vehicles equipped with sensors for generating image data used to create a virtual bottom view, according to an embodiment.

FIG. 4 illustrates a vehicle display displaying a virtual bottom view, including a perspective view (left) and bird-eye-view (right), according to an embodiment.

FIG. 5 illustrates a flow diagram of an example method of generating and displaying a virtual bottom view associated with a vehicle, according to an embodiment.

FIG. 6 illustrates a block diagram of a vehicle electronics control system, according to an exemplary embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Some portions of this description describe the embodiments of the disclosure in terms of algorithms and operations. These operations are understood to be implemented by computer programs or equivalent electrical circuits, machine code, or the like, examples of which are disclosed herein. Furthermore, these arrangements of operations may be referred to as modules or units, without loss of generality. The described operations and their associated modules or units may be embodied in software, firmware, and/or hardware.

Steps, operations, or processes described may be performed or implemented with one or more hardware or software modules, alone or in combination with other devices. Although the steps, operations, or processes are described in sequence, it will be understood that in some embodiments the sequence order may differ from that which has been described, for example with certain steps, operations, or processes being omitted or performed in parallel or concurrently.

References herein to a “parking zone” should be construed to include parking lots, parking garages, streets with parking spots (e.g., parallel or angled parking spots next to a drive lane on a road), and other similar spaces where several parking spots are concentrated or grouped together. A parking zone can include a physical area that is established for parking, storing, or keeping a vehicle for a period of time. The parking zone can include one or more markers, lines, signs, or other indications to facilitate parking or define aspects of the parking zone. For example, the parking zone may or may not include parking lines that define or allocate a physical area or space in which a vehicle is to park. The parking zone can include signs that provide parking restrictions, such as types of vehicles that can park in a parking space or spot (e.g., small vehicle, mid-size vehicle, full size vehicle, sports utility vehicle, truck, hybrid, electric vehicle), requirements (e.g., handicap sticker), or time constraints (e.g., 1 hour parking, 2 hour parking). The parking zone can be or include a designated area for the vehicle to be aligned such that a battery of the vehicle can be properly charged wirelessly from beneath.

Vehicle camera systems can generate a surround-view, 360-degree view, or bird-eye-view of the environment immediately surrounding the vehicle. In a two-dimensional surround view, a bird-eye-view of the vehicle's surroundings are shown on the display; in a three-dimensional surround view, the vehicle and its surroundings are shown in a three-dimensional representation, which is in spherical form. Since it is a three-dimensional representation of the surroundings in 360-degrees, the view can be fetched from any angle around the vehicle.

These camera views are generated by the system gathering images captured by cameras positioned at various locations around the vehicle, and applying image processing techniques such as identifying common features between the camera images, aligning the images according to the common features, and combining or stitching the images together to create a single view of the vehicle's surroundings for display.

These views generate valuable visual information supported by computer vision algorithms to assist in increasing the driver's visibility to the external environment. These views are particularly useful in parking situations, where the driver may find it helpful to see a live view of the vehicle's immediate surroundings, such as parking lines, cones, other vehicles, and the like. These views also help improve advanced driver assistance system (ADAS) functionalities for autonomous vehicles.

The generated view on the display may include a fake image, template, or mask of the vehicle. This image of the vehicle is not a live view of the vehicle, but rather a stock or pre-selected image of a vehicle with the same or similar make, model, and/or color of the vehicle. Vehicles are typically not equipped with a camera that captures live images of road surfaces below the vehicle. Therefore, a live view of the road surface beneath the vehicle is typically not available. The driver is therefore left unable to see potential hazards and objects beneath the vehicle. Moreover, when the driver wishes to align the vehicle with something underneath the vehicle (such as a vehicle wireless charging unit), the generated view may be of no help since nothing underneath the vehicle is displayed.

Moreover, because the images captured by the cameras are two-dimensional images, the driver is unable to see the true size or depth of various objects about the vehicle, including obstacles that may be beneath or very close to the vehicle.

Therefore, according to various embodiments disclosed herein, methods and systems for generating and displaying a virtual bottom view associated with a vehicle are provided. The virtual bottom view can include a live surround-view, 360-degree view, or bird-eye-view of the environment immediately surrounding the vehicle, along with a virtual view of the road surfaces and objects beneath the vehicle that are unable to be seen at that moment by the vehicle cameras. In other words, views that are currently outside of the field of view of the vehicle cameras are able to still be shown virtually.

In embodiments, the virtual bottom view may also benefit from a virtual mapping of the parking zone. Other cameras (e.g., cameras of other vehicles, or fixed cameras in the parking zone) can generate image data that can be relied upon by the vehicle that is generating the virtual bottom view of the area underneath the vehicle. For example, before the vehicle has driven over a certain area of the parking zone, other cameras not installed on the vehicle may capture images of that area of the parking zone. Then, as the vehicle drives off that certain area of the parking zone (rendering that area hidden from the field of view of the vehicle's own cameras), the virtual bottom view may be generated based on the previously-captured images from the other cameras.

In embodiments, Structure from Motion (SfM) is utilized to reconstruct the three-dimensional (3D) structure of an object or a scene from a series of two-dimensional images or frames captured from different viewpoints. For example, a 3D reconstruction of the roadway or objects in the parking zone can be displayed while the roadway or objects are in the field of view (FoV) of the vehicle's cameras. A 3D view of the objects can be generated and displayed on the vehicle display if the vehicle drives to a certain location that renders the objects outside the FoV (e.g. when the vehicle drives over the object). The SfM recovers the 3D structure of objects or scenes by relying on multiple two-dimensional (2D) images or frames together with the simultaneously determined movement characteristics of the vehicle. It involves extracting visual features or point cloud data (such as corners or distinctive points) from the images and then matching these features across different views to establish correspondences between them. The reconstructed 3D virtual view of the object can be displayed as part of the virtual bottom view, for example when the vehicle has passed over or is near the object.

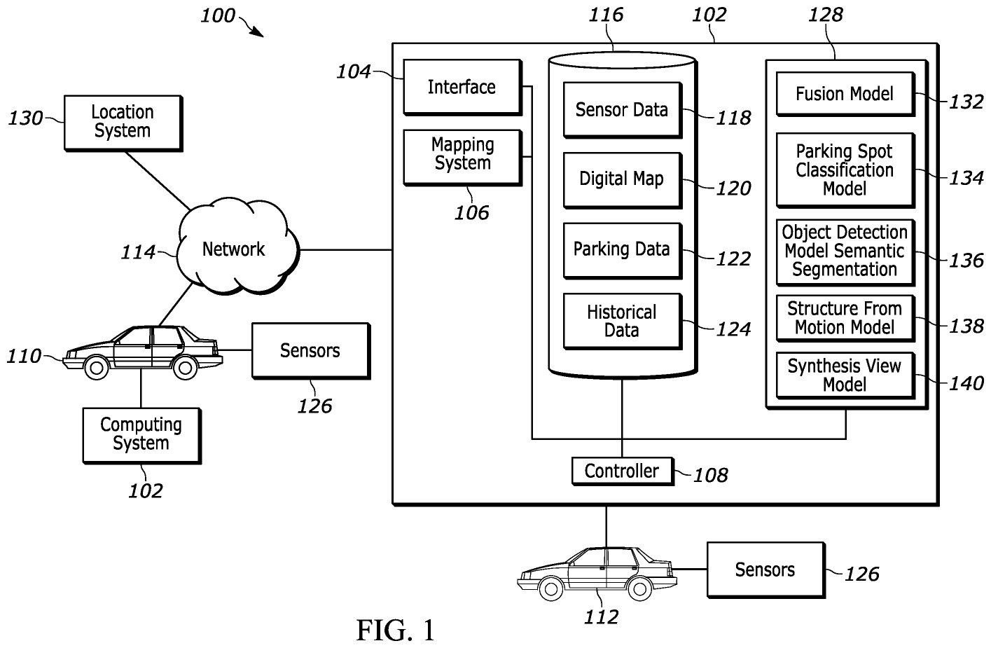

FIG. 1 illustrates a block diagram depicting an example system 100 for generating and displaying a virtual bottom view associated with a vehicle 110, according to an embodiment. The system 100 can include at least one computing system 102 for use in virtual bottom view generation, parking zone map generation, and updating based on sensor data, stored data, and utilizing one or more machine-learning models. The computing system can include at least one interface 104, and at least one mapping system 106 for generating and updating a digital map of a parking zone, and at least one controller 108. The computing system 102 can include hardware or a combination of hardware and software, such as communications buses, circuitry, processors, communications interfaces, among others. The computing system 102 can reside on or within a corresponding vehicle (e.g., a host vehicle). For example, FIG. 1 shows a first vehicle 110 with a computing system 102 on-board, and a second vehicle 112 with another or similar computing system 102 on-board. Alternatively (or in addition), all or part of the computing system 102 can reside on a remote server (e.g., the cloud) which is communicatively coupled to the vehicles 110, 112 via a network 114. Each of the first vehicle 110 and the second vehicle 112 (or their corresponding computing system 102) can be communicatively connected to the network 114 to each other (e.g., via vehicle-to-vehicle (V2V) communication), to the cloud (e.g., via vehicle-to-cloud (V2C) communication), and/or to one or more other systems (e.g., a global positioning system (GPS), or to one or more communications devices). For example, the vehicles may include one or more transceivers configured to establish a secure communication channel with another vehicle or the remote server wirelessly using one or more communication protocols, such as, for example, communication protocol based on vehicle-to-vehicle (V2V) communications, wireless local area network (WLAN) or wireless fidelity (WiFi, e.g., any variant of IEEE 802.11 including 802.11a/b/g/n), wireless personal area network (WPAN, e.g., Bluetooth, Zigbee), cellular (e.g., LTE, 3G/4G/5G, etc.), wireless metropolitan area network WIMAN (e.g., WiMax), and other wide area network, WAN technologies (e.g., iBurst, Flash-OFDM, EV-DO, HSPA, RTT, EDGE, GPRS), dedicated short range communications (DSRC), near field communication (NFC), and the like. This enables the exchange of information and data that is described herein.

The computing system 102 can also include at least one data repository or storage 116. The data repository 116 can include or store sensor data 118 (originating from the cameras or other sensors described herein). The sensor data 118 can include or store information collected by vehicle sensors 126. The sensor data 118 stored in memory can be recalled and used when constructing the virtual bottom view. In embodiments wherein the sensor 126 is a camera, the associated sensor data 118 may be images or image data. The sensor data 118 can also include information about available sensors, identifying information for the sensors, address information, internet protocol information, unique identifiers, data format, protocol used to communicate with the sensors, or a mapping of information type to sensor type or identifier. The sensor data 118 can store sensor data using timestamps and date stamps. The sensor data 118 can store sensor data using location stamps. The sensor data 118 can categorize the sensor data based on a parking zone or characteristics of a parking zone.

In embodiments, the data repository 116 can also include or store a digital map or digital map data 120, parking data 122, and historical data 124, described further below.

Vehicle sensors 126 that generate the sensor data 118 can include one or more sensing elements or transducers that captures, acquires, records or converts information about its host vehicle or the host vehicle's environment into a form for processing. The sensor 126 can acquire or detect information about parking zones. For example, the sensor 126 can generate sensor data 118 indicative of detected objects in the parking zone. The sensor 126 can detect a parking zone condition such as a road feature, object, boundary, intersection, lane, lane marker, hazard, or the like within the parking zone. The sensor 126 can also detect a feature of a particular parking space, such as symbols that represent the parking space is for handicapped, emergency vehicles only, pregnant women (expectant mothers), and the like. The sensor 126 can, for example, acquire one or more images of the parking zone, which can be processed using image processing and object recognition to identify or detect features indicative of a parking zone, e.g., a parking sign, a stop sign, a handicap parking sign, or surface markings on a parking zone. An associated processor (such as those described herein) can process the sensor data generated by the sensors in order to detect the various road features, objects, and the like described above.

As examples, the sensor 126 can be or include an image sensor such as a photographic sensor (e.g., camera), radar sensor, ultrasonic sensor, millimeter wave sensor, infra-red sensor, ultra-violet sensor, light detection sensor, lidar sensor, or the like. The sensor 126 can communicate sensed data, images or recording to the computing system 102 for processing, which can include filtering, noise reduction, image enhancement, etc., followed by object recognition, feature detection, segmentation processes, and the like. The raw data originating from the sensors 126 as well as the processed data by the computing system 102 can be referred to as sensor data 118 or image data that is sensed by an associated sensor 126.

The sensor 126 can also include a global positioning system (GPS) device that can determine a location of the host vehicle relative to an intersection, using map data with an indication of the parking zone. The GPS device can communicate with location system 130, described further below. The computing system 102 can use the GPS device and the map data to determine that the host vehicle (e.g., first vehicle 110) has reached the parking zone. The computing system 102 can use the GPS device and the map data to determine the boundaries of the parking zone. The sensor 126 can also detect (e.g., using motion sensing, imaging or any of the other sensing capabilities described herein) whether any other vehicle or object is present at or approaching the parking zone, and can track any such vehicle or object's position or movement over time for instance. The sensor 126 can also detect the relative position between another vehicle and a parking spot, e.g., whether or not a parking spot is occupied by a vehicle as indicated by at least a portion of the vehicle being between the boundaries of two adjacent parking spot lines.

The sensor 126 can also include a vehicle movement sensor, such as an inertial measurement unit (IMU), wheel encoder (e.g., wheel pulse transducer), or the like that are configured to generate associated sensor data indicating the movement characteristics of the vehicle. This can include vehicle speed, acceleration, deceleration, distance traveled, orientation, wheel turn angle, and the like. The generated vehicle movement data can be used by the SfM model in generating a 3D view of an object on the roadway.

In embodiments, using any one or more of the aforementioned types of sensors 126, the vehicle (e.g., first vehicle 110) is able to virtually map the parking zone. For example, the sensors calculate relative distances between detected objects and the sensor itself, and the computing system 102 can utilize a visual simultaneous localization and mapping (SLAM) system. Visual SLAM is a position detecting scheme in which a process of generating a digital map of an environment (such as a parking zone) and a process of acquiring a location of the sensor or vehicle itself are complementarily performed. In other words, characteristics of the environment about the vehicle as well as the location of the vehicle itself are determined simultaneously.

The mapping system 106 can implement visual SLAM (or similar technologies) to generate a digital map of the parking zone. The mapping system 106 is designed, constructed or operational to generate digital map data based on the data sensed by the one or more sensors 126. The digital map data structure (or referred to as digital map 120) can generate the digital map from, with or using one or more machine learning models or neural networks established, maintained, tuned, or otherwise provided via one or more machine learning models 128. The machine learning models 128 can be configured, stored, or established on the computing system 102 of the first vehicle 110, or on a remote server. The mapping system 106 can detect, from a first neural network and based on the data sensed by the one or more sensors 126, objects located at the parking lot. The mapping system 106 can perform, using the first neural network and based on the data sensed by the one or more sensors 126, scene segmentation. The mapping system 106 can determine, using the first neural network and based on the data sensed by the one or more sensors 126, depth information for the parking zone. The mapping system 106 can identify, from the first neural network 114 and based on the data sensed by the one or more sensors 126, one or more parking lines or parking spots in the parking zone. The mapping system 106 can construct the digital map based on the detected objects located at the parking zone, the scene segmentation, the depth information for the parking zone, and the one or more parking lines at the parking zone.

The mapping system 106 can create the digital map 120 based on the sensor data 118. This digital map 120 can be created via implemented visual SLAM, as described above. In one embodiment, the digital map 120 can include three dimensions on an x-y-z coordinate plate, and associated dimensions can include latitude, longitude, and range, for example. The digital map 120 can be updated periodically or reflect or indicate a motion, movement or change in one or more objects detected in the parking zone. For example, the digital map can include stationary objects associated with the scene, such as a curb, tree, lines, parking signs, or boundary of the parking zone, as well as non-stationary objects such as vehicles moving or a person moving (e.g., walking, biking, or running).

Various types of image processing models or machine learning models (generally referred to as models 128) are disclosed herein. The machine learning models utilized by the system 100 to generate the virtual bottom view or the digital map 120 can include any type of neural network, including, for example, a convolution neural network, deep convolution network, a feed forward neural network, a deep feed forward neural network, a radial basis function neural network, a Kohonen self-organizing neural network, a recurrent neural network, a modular neural network, a long/short term memory neural network, or the like. Each machine learning model 128 can maintain, manage, store, update, tune, or configure one or more neural networks and can use different parameters, weights, training sets, or configurations for each of the neural networks to allow the neural networks to efficiently and accurately process a type of input and generate a type of output.

One or more of the disclosed machine learning models 128 disclosed herein can be configured as or include a convolution neural network. The convolution neural network (CNN) can include one or more convolution cells (or pooling layers) and kernels, that can each serve a different purpose. The convolution kernel can process input data, and the pooling layers can simplify the data, using, for example, non-linear functions such as a max, thereby reducing unnecessary features. The CNN can facilitate image recognition. For example, the sensed input data can be passed to convolution layers that form a funnel, compressing detected features. The first layer can detect first characteristics, the second layer can detect second characteristics, and so on.

The convolution neural network can be a type of deep, feed-forward artificial neural network configured to analyze visual imagery. The convolution neural network can include multilayer perceptrons designed to use minimal preprocessing. The convolution neural network can include or be referred to as shift invariant or space invariant artificial neural networks, based on their shared-weights architecture and translation invariance characteristics. Since convolution neural networks can use relatively less pre-processing compared to other image classification algorithms, the convolution neural network can automatically learn the filters that may be hand-engineered for other image classification algorithms, thereby improving the efficiency associated with configuring, establishing or setting up the neural network, thereby providing a technical advantage relative to other image classification techniques.

One or more of the disclosed machine learning models 128 disclosed herein can include a CNN having an input layer and an output layer, and one or more hidden layers that can include convolution layers, pooling layers, fully connected layers, or normalization layers. The one or more pooling layers can include local pooling layers or global pooling layers. The pooling layers can combine the outputs of neuron clusters at one layer into a single neuron in the next layer. For example, max pooling can use the maximum value from each of a cluster of neurons at the prior layer. Another example is average pooling, which can use the average value from each of a cluster of neurons at the prior layer. The fully connected layers can connect every neuron in one layer to every neuron in another layer.

To assist in generating the virtual bottom view or the digital map 120, the computing system 102 can interface or communicate with a location system 130 via network 114. The location system 130 can determine and communicate the location of one or more of the vehicles 110, 112 during the performance of the virtual bottom view generation. The location system 130 can include any device based on a positioning system such as Global Navigation Satellite System (GNSS), which can include GPS, GLONASS, Galileo, Beidou and/or other regional systems. The location system 130 can include one or more cellular towers to provide triangulation. The location system 130 can include wireless beacons, such as near field communication beacons, short-range wireless beacons (e.g., Bluetooth beacons), or Wi-Fi modules.

The computing system 102 can be configured to utilize interface 104 to receive and transmit information. The interface 104 can receive and transmit information using one or more protocols, such as a network protocol. The interface 104 can include a hardware interface, software interface, wired interface, or wireless interface. The interface 104 can facilitate translating or formatting data from one format to another format. For example, the interface 104 can include an application programming interface that includes definitions for communicating between various components, such as software components. The interface 104 can be designed, constructed or operational to communicate with one or more sensors 126 to collect or receive information, e.g., image data. The interface 104 can be designed, constructed or operational to communicate with the controller 108 to provide commands or instructions to control a vehicle, such as the first vehicle 110. For example, the controller may be an engine controller, steering wheel controller, brake actuator, or the like that can autonomously maneuver the vehicle during a parking maneuvering event, for example. The information collected from the one or more sensors can be stored as shown by sensor data 118.

The interface 104 can receive the image data sensed by the one or more sensors 126 regarding an environment or characteristics of a parking zone. The sensed data received from the sensors 126 can include data detected, obtained, sensed, collected, or otherwise identified by the sensors 126. As explained above, the sensors 126 can be one or more various types of sensors, and therefore the data received by the interface 104 for processing can be data from a camera, data from an infrared camera, lidar data, laser-based sensor data, radar data, transducer data, or ultrasonic sensor data. Because this data can, when processed, enable information about the parking zone or object to be visualized, this data can be referred to as image data.

The data sensed from the sensors 126 can be received by interface 104 and delivered to a processor for detecting various qualities or characteristics of a parking zone (e.g., parking lines, handicapped spaces, etc.) or objects (e.g., potholes, hazards, charging stations, etc.) in the parking zone as explained above utilizing techniques such as segmentation, CNNs, or other machine learning models. For example, the processor can execute one or more neural networks or machine learning models 128 to detect objects, scene segmentation, roads, terrain, trees, curbs, obstacles, depth or range of the parking lot, parking line detection, parking marker detection, parking signs, or other objects at or associated with the parking zone. The computing system 102 can train the machine learning models 128 using historical data 124. This training can be performed remote from a computing process 102 installed on a vehicle 110, 112. In other words, the computing system 102 may be on a remote server for at least these purposes. Once trained, the models can be communicated to or loaded onto the vehicles 110, 112 via network 114 for execution.

Once generated, the sensor data 118 and digital map 120 can be stored in storage 116 and accessed by other vehicles. For example, the computing system 102 of a first vehicle 110 may be utilized to at least in part generate sensor data 118 and the digital map 120, whereupon that sensor data 118 and/or digital map 120 can be accessed by the computing system 102 of a second vehicle 112 that subsequently enters the parking zone. The computing system 102 of the second vehicle 112 (and other vehicles) can be utilized to generate the virtual bottom view or based upon the sensor data 118 from the first vehicle 110, or the sensor data captured form the second vehicle 112. In addition, the computing system 102 of both vehicles 110, 112 can be used to generate and continuously update parking data 122 in real-time. The parking data 122 represents data indicating characteristics of particular parking spots. For example, the parking data 122 can include a location of one or more parking spots, whether or not those parking spots are occupied or not occupied by a vehicle, and whether one or more of the parking spots are reserved for handicapped individuals, emergency vehicles only, vehicles carrying pregnant mothers, and the like, as described above. These qualities of the individual parking spots can be determined via the image data received from sensors 126 either when the digital map is generated, and/or when the digital map is updated by a second vehicle 112 or other vehicles. By updating the parking data 122 in real-time, a subsequent vehicle that enters the parking zone can be provided with live, accurate information about, for example, which parking spots are occupied or unoccupied, where the parking lines are located, and the like which can be beneficial in generating the virtual bottom view.

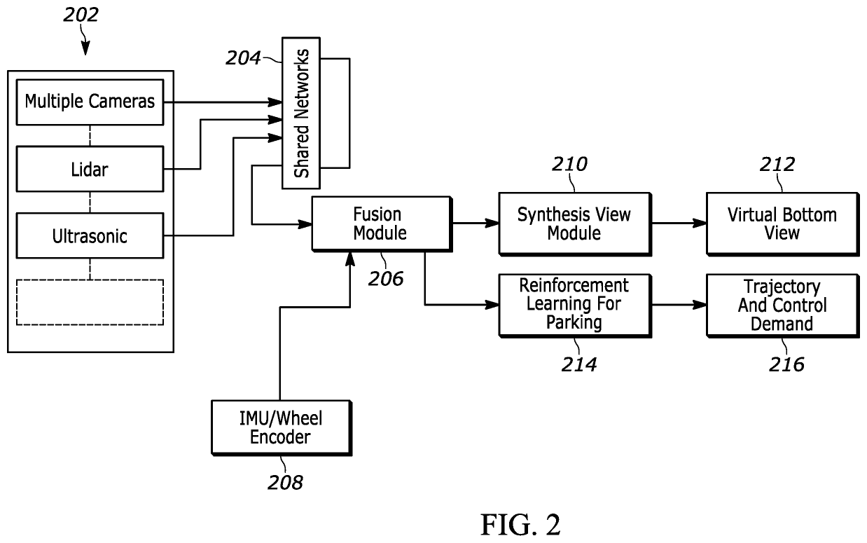

As described above, one or more machine learning models 128 can be relied upon to perform the various functions described herein. These machine learning models 128 can include a fusion model 132, a parking spot classification model 134, an object detection model 136, a Structure from Motion (SfM) model 138, and a synthesis view model 140. The fusion model 132 with be described further with reference to FIG. 2; it is trained and configured to receive and fuse the image data, vehicle movement data, and other data to perform the SfM and generate a virtual 3D view of an object in the parking zone. During so, it can perform object detection and classification as described above, so that the SfM can focus its processing efforts on only a particular object instead of the entire scene.

The parking spot classification model 134 is trained and configured to, based on the above data, perform image classification (e.g., segmentation) to generate and update parking data relating to the parking spaces of the parking zone. For example, the parking spot classification model 134 can be a machine learning model that determines whether each parking spot is a normal parking spot, a handicapped parking spot, a charging station for an electric vehicle (and, for example, whether that charging station is for wireless charging or charging by cable), and/or whether each parking spot has an allowed duration of parking (e.g., 1 hour, 2 hours, etc.). The output of this parking spot classification model 134 can be used to update the digital map 120 and parking data 122 if necessary.

The objection detection model 136 is trained and configured to, based on the above data, detect objects or obstacles in the parking zone. This can include parking lines used to determine whether a parking spot is present. The objection detection model 136 can, for example, determine the presence of a vehicle in a parking spot, thus enabling a determination that a parking spot is occupied. The objection detection model 136 can also determine the presence of a pothole, cone, debris, or other object in the parking zone, which can be stored in storage 116 and used to generate the virtual bottom view, and/or communicated to other vehicles (e.g., vehicle 112) that subsequently enter the parking zone. Features of the object detection model can also be incorporated into the SfM model. In other embodiments, SfM functions are performed not by a specific designated model, but instead by relying on outputs from other machine learning models such as the object detection model, for example semantic segmentation. In an embodiment, a semantic segmentation model is utilized on the image data to categorize a portion of the parking zone in the image data as a particular object, such as a parking line, pothole, or the like. Labeling the particular object as a certain class can help aid the 3D reconstruction of the feature in the SfM model described below. For example, if the object is labeled as a traffic cone, the SfM model can have some predictability in its analysis when operating to reconstruct the 3D image of the object.

The SfM model 138 is configured to perform the SfM features described herein. In embodiments the SfM model 138 is utilized to reconstruct the 3D structure of an object or a scene from a series of two-dimensional images or frames captured from cameras mounted about the vehicle 110 at different viewpoints. Sensor data 118 in the form of image data can be utilized for this. For example, a 3D reconstruction of the roadway or objects in the parking zone can be displayed while the roadway or objects are in the field of view of the vehicle's cameras. The SfM recovers the 3D structure of objects or scenes by relying on multiple two-dimensional (2D) images or frames together with the simultaneously determined movement characteristics of the vehicle.

The SfM model 138 can be configured to extract visual features or point cloud data (such as corners or distinctive points) from the images and then match these features across different views to establish correspondences between them. The point clouds can be generated from the cameras themselves. For example, by capturing multiple images of an object or scene from different viewpoints, the SfM model can triangulate the positions of visual features across these images to reconstruct the 3D structure and generate a point cloud. In other embodiments, the point clouds can be generated via other image sensors, such as LiDAR and then fused with the image data. For example, one or more LiDAR sensors can emit laser pulses and measure the time it takes for the pulses to return after hitting the object in the parking zone; this data is used to generate the 3D point clouds of the object. With either camera or LiDAR formation of point clouds, each point in the point cloud may contain data such as spatial coordinates, color, intensity, reflectance information, and the like. This data can be matched across the various 2D views to generate a 3D structure and populate a 3D view. As will be described below, this 3D view or data can be stored and the recalled for when the object is no longer in the field of view, at which point the 3D view of the object can be synthesized with the live view of the parking zone that is in the field of view to enable the occupant to see a view of the object even when it is not in view of the cameras.

The synthesis view model 140 is configured to synthesize the 3D view generated from the SfM model 138 with the live view of the cameras, for example when the object is out of view of the cameras. This may be considered a form of augmented reality. In embodiments, once the 3D structure is reconstructed by the SfM model 138, the current pose (position and orientation) of the live vehicle and/or the vehicle's cameras are estimated. This can be done based on the sensor data generated from other vehicle sensors 126 (e.g., vehicle movement sensors), such as an inertial measurement unit (IMU), wheel encoder (e.g., wheel pulse transducer), or the like that are configured to generate associated sensor data indicating the movement characteristics of the vehicle.

The reconstructed 3D scene of the parking zone that is currently out of the field of the view of the cameras can then be rendered and superimposed onto the live camera feed. For example, the area of the parking zone beneath the vehicle may be out of view of the cameras. Therefore, the reconstructed 3D scene of the parking zone beneath the vehicle (and any objects there) can be reconstructed and superimposed onto the view shown on the vehicle display (e.g., bird-eye-view or whatever view is displayed on the vehicle display, such as during a parking maneuver) in the areas of the display associated with the parking zone that is not in the current field of view of the vehicle cameras. The process involves continuous updates of the virtual scene's rendering based on the real-time camera movement and changes in the scene captured by the live camera.

In an embodiment, to combine the reconstructed 3D scene of the parking zone with the live camera feed, the point cloud acts as a reference model. The point cloud can provide a detailed spatial representation of the SfM-generated scene, enabling accurate alignment with the live camera's view. The point cloud data can also be used (e.g., along with the vehicle movement sensors) to estimate the camera's pose concerning the reconstructed 3D scene. By matching the features observed in the live camera view with corresponding features in the point cloud, techniques such as Iterative Closest Point (ICP) or feature-based registration methods can estimate the camera's position and orientation. Once the camera's pose is estimated and aligned with the point cloud, the virtual content generated from the SfM reconstruction can be accurately rendered and overlaid onto the live camera feed. The point cloud's spatial information helps in positioning the virtual objects or scene components within the live camera view at the correct locations and orientations. As the vehicle camera moves in the parking zone, the point cloud-based registration and tracking techniques continuously update the alignment and rendering of the virtual content, ensuring that the synthesized view remains synchronized with the live camera feed.

FIG. 2 is an operational diagram for implementing the system of FIG. 1, according to an embodiment. The various operations illustrated here can be performed by one or more system, component, or function depicted in FIG. 1. For example, the operations can be performed by computing system 102, mapping system 106, controller 108, and the various machine learning models 128 disclosed above. At 202, the computing system can receive, identify or collect data sensed by one or more sensors, such as those described above (e.g., camera, lidar, ultrasonic, etc.). The computing system can collect the data in a raw format or preprocessed format. In some cases, the computing system can collect the data responsive to a request to collect data. For example, the computing system can collect the data in response to the vehicle entering a parking mode, either as manually indicated by the driver (e.g., by pressing a button) or automatically indicated based on the vehicle traveling at a low speed and the location of the vehicle being determined to be entering or becoming closer a particular parking zone.

At 204, the computing system can pass the data collected from 202 to shared networks or shared convolution layers of a neural network. The shared networks can include one or more of the machine learning models 128 described above, and/or can include multiple sub-neural networks of a particular model. The data collected from 202 can, for example, be fed into shared networks that include an input layer, one or more hidden layers (e.g., convolution layers, pooling layers, weighted layers), and one or more output layers. The final output of one or more of the shared networks can be, for example, object detection information, depth information, parking line detection information, a generation of the virtual bottom view, or other information such as those disclosed above regarding the environment sensed by the sensors about the parking zone.

At 206, a fusion module (e.g., fusion model 132) is executed which fuses one or more of the outputs of the shared networks 204 to allow subsequent machine learning models (e.g., SfM model, synthesis view module 140) to output accurate results. In embodiments, the computing system can generate point cloud data, a 3D view via the SfM model, and the like as described above. To do so, the fusion model 206 relies on data from the vehicle movement sensors 208, such as an IMU or wheel encoder. This data can be used to create the 3D object reconstruction via SfM, as awareness of the vehicle's location and pose relative to the object maybe required for accurate SfM processes. Object detection (and semantic segmentation, for example) can be utilized such that the SfM model can be performed only on a detected object or a particular class of object.

In embodiments where mapping is utilized, the computing system can generate or update the digital map based on the fusion of depth, object/obstacle detection, road information and location information described above. The computing system can generate the digital map using the object detection information, scene segmentation information, depth information, parking line detection, and the like generated from the one or more machine learning models 128, 204. In an embodiment, a pre-generated high definition map (HD map) is provided to the fusion module at 206. The pre-generated high definition map can be a digital map such as digital map 120 that was already generated from data received from one or more vehicles that have already traversed the parking zone. In an embodiment, parking spot occupancy information 210 (e.g., parking data 122) is transferred from a remote server to the fusion model.

In embodiments, the fusion model 132 also utilizes the vehicle state (e.g., as detected from one or more movement sensors, IMU, wheel encoder, etc.) to compensate the sensor movement and perform online calibration as needed. The fusion model 132 can fuse sensor information from the perception sensor and the can bus signal of the vehicle state.

At 210, a synthesis view module can be executed by the computing system to synthesize the computer-generated views (e.g., via SfM) with the live view from the vehicle cameras. The synthesis view module 210 can be the synthesis view model 140 from FIG. 1. In an embodiment, a view of the area beneath the vehicle that is out of view of the vehicle cameras is generated via past image data generated and stored when the vehicle was driving near that area of the parking zone. Taking a bird's-eye-view approach for example, typical prior art bird's-eye-view include a stock image of a vehicle overlaid onto the live camera views of the external environment, and nothing beneath the vehicle can be seen. But here, a view of beneath the vehicle can be reconstructed virtually by using past image data and SfM for any objects. The same can be done for other views, for example perspective views of the vehicle when performing parking maneuvers.

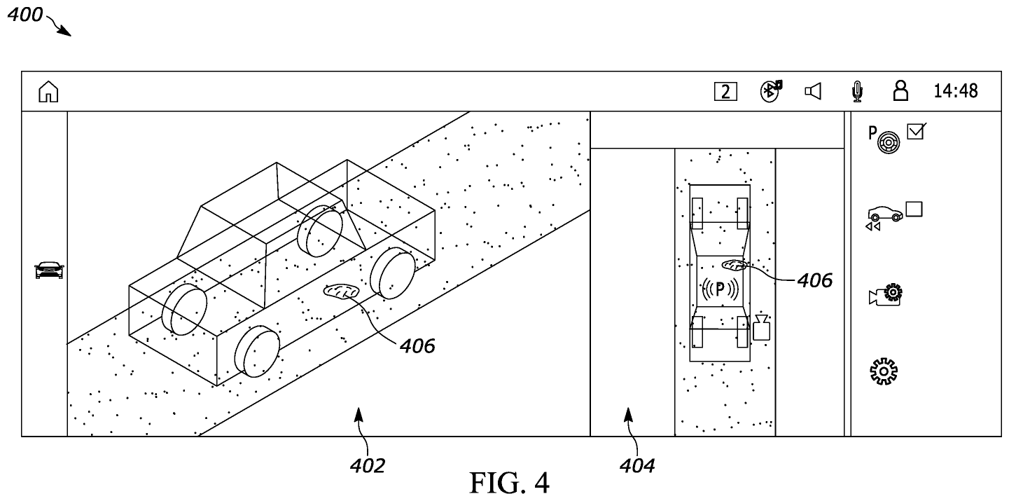

At 212, the virtual bottom view is displayed. An example of the virtual bottom view is shown in FIG. 4, described below. The virtual bottom view can be displayed on a vehicle device, such as liquid crystal display (LCD), or active matrix display, for displaying information to a user such as a driver of the vehicle. The display can be part of a vehicle dashboard, and can be part of the computing system 102. In another embodiment, the display device is a screen of a mobile device such as a smart phone, wearable device (e.g., smart watch), or the like. The display device may be associated with a particular vehicle in that the display device is mounted to that vehicle, or a driver or occupant within the vehicle is operating the display device. The display device may be linked to the vehicle, such as via Phone as a Key (PAAK) technology.

The fusion model can also enable autonomous vehicle operations to take place, such as autonomous parking maneuvers. At 214, reinforcement learning for parking can be executed. An autonomous parking system can utilize one or more reinforcement learning techniques to navigate and maneuver the vehicle within the parking zone. For example, Q-learning, Deep Q Networks (DQN), Deep Deterministic Policy Gradients (DDPG) and the like can be used based upon the fused data from the various sensors. Ultimately, trajectory and control commands are issued at 216, directing a controller (e.g., controller 108) to propel and/or maneuver the vehicle about the parking zone based on the sensed environment.

Reinforcement learning 214 can also utilize the generated virtual bottom view. For example, reinforcement learning can be utilized to understand characteristics of the parking spot, the detected objects beneath the vehicle, and the parking maneuvers taken by the driver to learn what actions are considered to be acceptable during a parking maneuver. For example, if the virtual bottom view indicates the presence of a pothole beneath the vehicle attempting to park, then the driver or vehicle can be commanded to maneuver the vehicle in a particular manner to avoid the pothole while still performing an adequate parking maneuver (e.g., the vehicle ending its parking action between both parking lines). Other semi-autonomous or fully-autonomous driving commands can be provided from controller 108 described above.

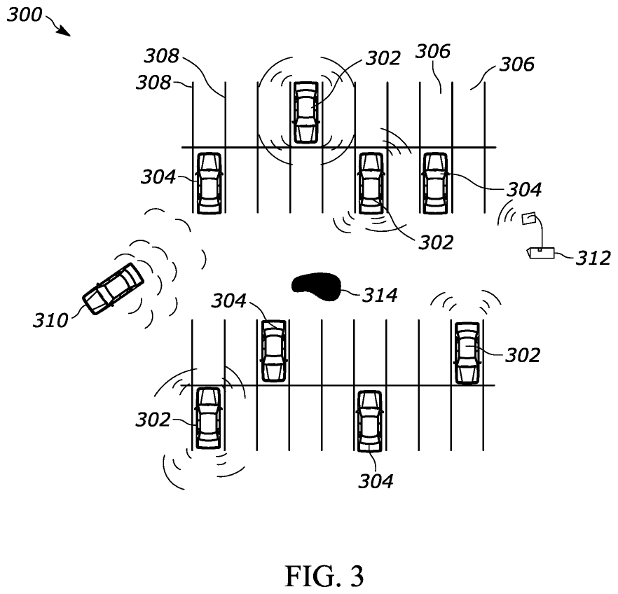

The image data used to create the virtual bottom view need not originate from the vehicle itself, but rather can originate from other vehicles, or from one or more roadside units (RSUs) or other fixed, stationary infrastructure device. As an example, FIG. 3 illustrates an overhead schematic view of a parking zone 300 and various vehicles 302 equipped with sensors for generating image data that can be used for generation of the virtual bottom view. For example, the parking zone 300 may include a plurality of vehicles 302 with a computing system (e.g., computing system 102) described above, or at least some components of the described computing system. Each of the vehicles 302 can be able to generate image data and/or perform SfM, and that data can be communicated to vehicle 310 for generation of the virtual bottom view on a display device of the vehicle 310.

The sensor data generated from the vehicles 302 can also be used to create a digital map of the parking zone, according to an embodiment. For example, the parking zone 300 may include a plurality of vehicles 302 with a computing system (e.g., computing system 102) described above, or at least some components of the described computing system. Each of the vehicles 302 is able to generate or update the digital map, perform parking spot classifications, and the other functions described above. The parking zone 300 may also include other vehicles 304 that do not have the capabilities of the computing systems 102 described herein. As shown, each of the illustrated vehicles 302, 304 are located within a respective parking spot 306 defined between a pair of parking lines 308, the presence of which can be determined via the machine learning explained above. As each vehicle 302 enters the parking zone 300 to park, the computing system of that vehicle 302 performs the mapping and updating processes described herein. For example, each vehicle can perform the visual SLAM processes, or update a previously-generated digital map 120 retrieved from storage upon entering the associated parking zone 300. The updating can include informing the remote server or other vehicle of one or more of the parking spots 306 being occupied or unoccupied by a vehicle, thereby causing the remote server to update the parking data. The vehicles 302 can update any of the data that forms the digital map and parking data described above so that a subsequent vehicle 310 that enters the parking zone 300 can download or retrieve the digital map 120 and parking data 122. This allows the computing system 102 of the vehicle 310 to determine which of the parking spots 306 in the parking zone 300 are available for parking (i.e., unoccupied), which of the parking spots 306 are labeled as handicapped, and so on. The vehicle 310 can then be commanded to drive to an appropriate spot that matches the desires of the vehicle or driver. For example, if the vehicle 310 and/or its driver determines that it is desirable to park in a parking spot equipped with a vehicle battery charger, the label associated with that particular parking spot is transferred from one or more of the other vehicles 302 and/or the remote server to the vehicle 310, whereupon the computing system 102 of that vehicle 310 can command (e.g., via controller 108) the vehicle 310 to drive to and park in the parking spot with the charger.

The parking zone 300 may also include one or more roadside units (RSUs) 312 or other fixed, stationary infrastructure device having wireless communication capabilities (e.g., DSRC, Wi-Fi, etc. as described above). The RSU 312 can have portions of a computing system 102 (e.g., sensor 126, transceiver, etc.) which allow the RSU 312 to detect the presence and location of vehicles in the parking zone 300. This enables either the RSU 312 or the computing system 102 of a remote server to perform updating of the digital map 120 to include real-time parking data, such as which parking spots are occupied or unoccupied. The RSUs 312 can also generate image data that can be used by the vehicle 310 in generation of the virtual bottom view. In short, the RSUs 312 can have one or more of the computing capabilities of the computing systems 102 described herein, wherein the RSU 312 provides a permanent structure giving capabilities for generation of the virtual bottom view and/or continuous real-time updating of the digital map and parking data.

One or more of the computing systems 102 equipped in the vehicles 302, 310 or RSU 312 can also determine the presence and location of an obstacle 314 in the parking zone. The obstacle 314 may be a pothole, animal, debris, patch of ice, or other object that would be beneficial for the driver or vehicle 310 to know of. This may alter the decision of the vehicle or its driver to park in a particular parking spot. For example, if a large object 314 is detected to be present in front of a parking spot, the computing system 102 of the vehicle 310 or the driver may decide not to park in that particular parking spot. Also, the determination of the presence of the object can be communicated to vehicle 310 so that the vehicle 310 can recognize the object upon approach, and perform SfM during approach so that a view of the object 314 can be provided on the display device as the vehicle 310 travels over the object 314, rendering it out of the FoV of the cameras on the vehicle 310.

FIG. 4 illustrates an example of a vehicle display 400 displaying a virtual bottom view, according to an embodiment. Here, both a perspective view 402 (left) and bird-eye-view 404 (right) are shown on the vehicle display. Both of these views can be shown in response to the vehicle entering a parking mode, for example. The perspective view is a view of the parking zone from the perspective of a virtual camera rearward and above the vehicle. The perspective view can be generated using a neural network, such as those described above, and including EpipolarNVS. The bird-eye-view is a view of the parking zone from the perspective of a virtual camera directly above the vehicle. Both views can be provided to assist the driver to see his/her surroundings during parking maneuvers, for example. Both views can be provided via stitching of images taken by the vehicle cameras.

Utilizing the teachings described herein, such as the SfM model and synthesis model, the area of the parking zone directly beneath the vehicle can also be shown and synthesized with the live view from the vehicle cameras. This allows the driver to visually see an object 406 (e.g., rock or pothole) that may be located directly beneath the vehicle, even though this object 406 may be out of the field of view of the vehicle cameras.

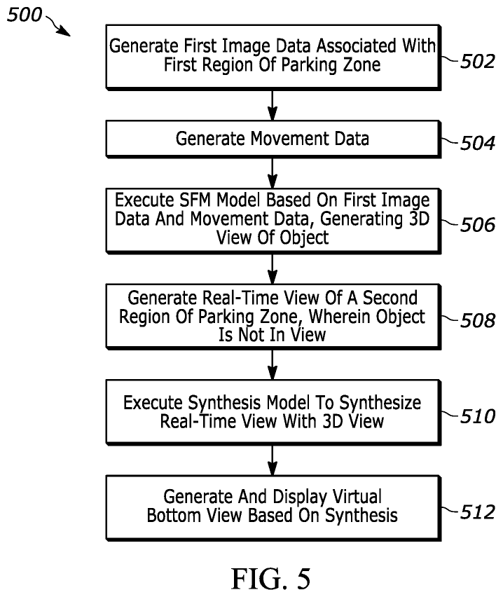

FIG. 5 illustrates a method 500 of generating and displaying a virtual bottom view associated with a vehicle, according to an embodiment. The method can be performed or executed by one or more system, component, or function depicted in FIGS. 1, 2, and 6, including, for example, one or more computing systems 102. In some alternative implementations, the functions noted in the flow chart blocks can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flow chart illustration, and combinations of blocks in the block diagrams and/or flow chart illustration, can be implemented by special purpose hardware-based systems that perform the specified functions or acts or carry out combinations of special purpose hardware and computer instructions.

At 502, first image data is generated via one or more cameras. The cameras can be mounted to the vehicle, another vehicle, a RSU, or the like. The first image data is associated with a first region of a parking zone that the vehicle is driving in. The parking zone also includes an object, such as a pothole or lane line, or others as described above.

At the same time (e.g., during a first time period) at 504 movement data is generated via one or more movement sensors (e.g., IMU). The movement data is associated with the movement of the vehicle while the first image data is generated. For example, the relative location, pose, orientation and the like of the vehicle is depicted in the movement data.

At 506, a SfM model is executed based on the first image data generated during the first time period, and based on the associated movement data generated therewith. The SfM model generates a three-dimensional view of the first region, specifically the object in the first region.

Subsequently, during a second time period, at 508 a real-time view of a second region of the parking zone is generated via the one or more cameras. The real-time view is a live view of the environment within the field of view of the one or more cameras. During this time, the object is not in the field of view. For example, the object is underneath the vehicle and the cameras do not have a field of view that includes the area beneath the vehicle.

At 510, a synthesis model is executed to synthesize the real-time view with the three-dimensional view. For example, the real-time view of the region of the parking zone not underneath the vehicle can be synthesized with the three-dimensional view generated from the SfM model of the region of the parking zone that is currently underneath the vehicle. Thus, a live view and a reconstructed virtual view can be synthesized.

At 512, a virtual bottom view is generated and displayed on a vehicle display during a parking event. The virtual bottom view is generated based on the synthesis of the real-time view and the three-dimensional view, enabling a user to see a three-dimensional virtual view of the object when the object is not in the current field of view during the parking event. An example of the virtual bottom view is shown in FIG. 4.

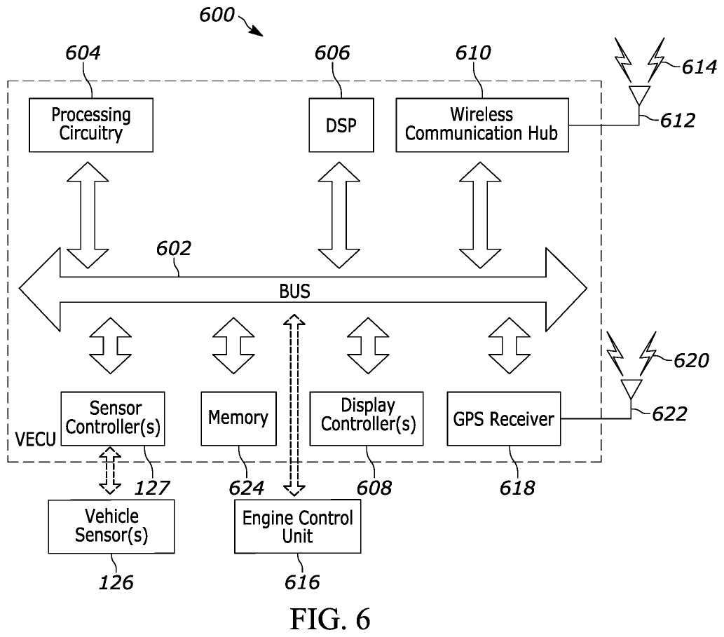

FIG. 6 is a block diagram of internal components of an exemplary embodiment of a computing system 600. The computing system 600 may include or be used to implement the computing systems described above. In this embodiment, the computing system 600 may be embodied at least in part in a vehicle electronics control unit (VECU). It should be noted that FIG. 6 is meant only to provide a generalized illustration of various components, any or all of which may be utilized as appropriate. It can be noted that, in some instances, components illustrated by FIG. 6 can be localized to a single physical device and/or distributed among various networked devices, which may be disposed at different physical locations.

The computing system 600 has hardware elements that can be electrically coupled via a BUS 602. The hardware elements may include processing circuitry 604 which can include, without limitation, one or more processors, one or more special-purpose processors (such as digital signal processing (DSP) chips, graphics acceleration processors, application specific integrated circuits (ASICs), and/or the like), and/or other processing structure or means. The above-described processors can be specially-programmed to perform the operations disclosed herein, including, among others, image processing, data processing, and implementation of the machine learning models described above. Some embodiments may have a separate DSP 606, depending on desired functionality. The computing system 600 can also include one or more display controllers 608, which can control the display devices disclosed above, such as an in-vehicle touch screen, screen of a mobile device, and/or the like.

The computing system 600 may also include a wireless communication hub 610, or connectivity hub, which can include a modem, a network card, an infrared communication device, a wireless communication device, and/or a chipset (such as a Bluetooth device, an IEEE 802.11 device, an IEEE 802.16.4 device, a WiFi device, a WiMax device, cellular communication facilities including 4G, 5G, etc.), and/or the like. The wireless communication hub 610 can permit data to be exchanged with network 114, wireless access points, other computing systems, etc. For example, image data or SfM results can be communicated between vehicles via the wireless communication hub 610. The communication can be carried out via one or more wireless communication antenna 612 that send and/or receive wireless signals 614.

The computing system 600 can also include or be configured to communicate with an engine control unit 616, or other type of controller 108 described herein. In the case of a vehicle that does not include an internal combustion engine, the engine control unit may instead be a battery control unit or electric drive control unit configured to command propulsion of the vehicle. In response to instructions received via the wireless communications hub 610, the engine control unit 616 can be operated in order to control the movement of the vehicle during, for example, a parking procedure.

The computing system 600 also includes vehicle sensors 126 such as those described above with reference to FIG. 1. These sensors can include, without limitation, one or more accelerometer(s), gyroscope(s), camera(s), radar(s), LiDAR(s), odometric sensor(s), and ultrasonic sensor(s), as well as magnetometer(s), altimeter(s), microphone(s), proximity sensor(s), light sensor(s), and the like. These sensors can be controlled via associated sensor controller(s) 127.

The computing system 600 may also include a GPS receiver 618 capable of receiving signals 620 from one or more GPS satellites using a GPS antenna 622. The GPS receiver 618 can extract a position of the device, using conventional techniques, from satellites of an GPS system, such as a global navigation satellite system (GNSS) (e.g., Global Positioning System (GPS)), Galileo, GLONASS, Compass, Galileo, Beidou and/or other regional systems and/or the like.

The computing system 600 can also include or be in communication with a memory 624. The memory 624 can include, without limitation, local and/or network accessible storage, a disk drive, a drive array, an optical storage device, a solid-state storage device, such as a RAM which can be programmable, flash-updateable and/or the like. Such storage devices may be configured to implement any appropriate data stores, including without limitation, various file systems, database structures, and/or the like. The memory 624 can also include software elements (not shown), including an operating system, device drivers, executable libraries, and/or other code embedded in a computer-readable medium, such as one or more application programs, which may comprise computer programs provided by various embodiments, and/or may be designed to implement methods, and/or configure systems, provided by other embodiments, as described herein. In an aspect, then, such code and/or instructions can be used to configure and/or adapt a general purpose computer (or other device) to perform one or more operations in accordance with the described methods, thereby resulting in a special-purpose computer.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. These memory devices may be non-transitory computer-readable storage mediums for storing computer-executable instructions which, when executed by one or more processors described herein, can cause the one or more processors to perform the techniques described herein. The processor and the memory can be supplemented by, or incorporated in, special purpose logic circuitry.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A system for generating and displaying a virtual bottom view associated with a vehicle, the system comprising:
a plurality of cameras;
one or more movement sensors; and
a processor programmed to:
generate, via the one or more cameras and during a first time period, first image data associated with a first region of a parking zone external to the vehicle, wherein the first region of the parking zone includes an object;
generate, via the one or more movement sensors, movement data associated with movement of the vehicle while the first image data is generated;
execute a Structure from Motion (SfM) model based on the first image data generated during the first time period and the associated movement data, wherein the execution of the SfM model generates a three-dimensional view associated with the object;
generate, via the one or more cameras and during a second time period subsequent the first time period, a real-time view of a second region of the parking zone within a current field of view of the one or more cameras, wherein the object is not in the current field of view during the second time period;
execute a synthesis model to synthesize the real-time view with the three-dimensional view during the second time period in which the object is not in the current field of view; and
generate and display the virtual bottom view on a vehicle display during a parking event, wherein the virtual bottom view is generated based on the synthesized real-time view and the three-dimensional view, enabling a user to see a three-dimensional virtual view of the object when the object is not in the current field of view during the parking event.

2. The system of claim 1, wherein the execution of the synthesis model further synthesizes the real-time view generated during the second time period with the first image data generated during the first time period.

3. The system of claim 1, wherein the processor is further programmed to:
generate a transparent image of the vehicle on the virtual bottom view, wherein the first region of the parking zone is displayed beneath the transparent image.

4. The system of claim 3, wherein the three-dimensional view associated with the object is displayed beneath the transparent image.

5. The system of claim 1, wherein the virtual bottom view is a bird-eye-view of the parking zone.

6. The system of claim 1, wherein the virtual bottom view is a perspective view of the parking zone.

7. The system of claim 1, wherein the processor is further programmed to:
execute a semantic segmentation model on the first image data to categorize a portion of the first image data as the object;
wherein the SfM model is executed on the portion of the first image data.

8. The system of claim 7, wherein the semantic segmentation model categorizes the object as a vehicle wireless charging unit.

9. The system of claim 8, wherein the processor is further programmed to:
issue autonomous vehicle control commands to maneuver the vehicle such that a portion of the vehicle aligns with the vehicle wireless charging unit;
wherein the virtual bottom view is displayed during the maneuver.

10. A system for generating and displaying a virtual bottom view associated with a vehicle, the system comprising:
one or more cameras configured to generate image data associated with a parking zone;
one or more vehicle sensors configured to generate movement data associated with movement of the vehicle; and
one or more processors programmed to:
receive the image data from the one or more cameras generated during movement of the vehicle;
execute a semantic segmentation model on the received image data to categorize a portion of the received image data as being associated with an object in the parking zone;
execute a Structure from Motion (SfM) model on the categorized portion of the image data and the movement data, wherein the execution of the SfM model generates a three-dimensional view of the object;
generate the virtual bottom view based on the image data, wherein the virtual bottom view includes a virtual view of an area of the parking zone that is not within a current field of view of the one or more cameras, and wherein the virtual view includes the three-dimensional view of the object; and
display the virtual bottom view on a vehicle display during a parking event, enabling a user to see the three-dimensional view of the object when the object is not within the current field of view of the one or more cameras.

11. The system of claim 10, wherein the one or more processors is further programmed to:
generate a real-time view of the parking zone based on the image data;
synthesize the real-time view of the parking zone and the three-dimensional view of the object to yield a synthesized view; and
display the synthesized view on the vehicle display during the parking event.

12. The system of claim 10, wherein the virtual bottom view includes a transparent image of the vehicle, wherein the area of the parking zone that is not within the current field of view of the one or more cameras is displayed beneath the transparent image.

13. The system of claim 10, wherein the virtual bottom view includes a bird-eye-view of the parking zone.

14. The system of claim 10, wherein the virtual bottom view includes a perspective view of the parking zone.

15. The system of claim 10, wherein:
the semantic segmentation model determines that the object is a vehicle wireless charging unit;
the one or more processors is further programmed to issue autonomous vehicle control commands to maneuver the vehicle such that a portion of the vehicle aligns with the vehicle wireless charging unit; and
the virtual bottom view is displayed during the maneuver.

16. A method of generating and displaying a virtual bottom view associated with a vehicle, the method comprising:
generating, via one or more cameras and during a first time period, first image data associated with a first region of a parking zone external to the vehicle, wherein the first region of the parking zone includes an object;
generating, via one or more movement sensors, movement data associated with movement of the vehicle while the first image data is generated;
executing a Structure from Motion (SfM) model based on the first image data generated during the first time period and the associated movement data, wherein the executing of the SfM model generates a three-dimensional view associated with the object;
generating, via the one or more cameras and during a second time period subsequent the first time period, a real-time view of a second region of the parking zone within a current field of view of the one or more cameras, wherein the object is not in the current field of view during the second time period;
executing a synthesis model to synthesize the real-time view with the three-dimensional view during the second time period in which the object is not in the current field of view; and
generating, for display on a vehicle display, the virtual bottom view during a parking event, wherein the virtual bottom view is generated based on the synthesized real-time view and the three-dimensional view, enabling a user to see a three-dimensional virtual view of the object when the object is not in the current field of view during the parking event.

17. The method of claim 16, wherein the execution of the synthesis model further synthesizes the real-time view generated during the second time period with the first image data generated during the first time period.

18. The method of claim 16, further comprising:
displaying a transparent image of the vehicle on the virtual bottom view, wherein the first region of the parking zone is displayed beneath the transparent image.

19. The method of claim 18, wherein the three-dimensional view associated with the object is displayed beneath the transparent image.

20. The method of claim 16, further comprising:
executing a semantic segmentation model on the first image data to categorize the object as a vehicle wireless vehicle charging unit.
